(19) United States
(12) Patent Application Publication
(10) Pub. No.: US 2025/0175044 A1
(43) Pub. Date: May 29, 2025

(54) ROTOR FOR ELECTRIC MOTOR, ELECTRIC MOTOR, AND ELECTRIC MOTORCYCLE

(71) Applicant: VERGE MOTORCYCLES OY, Helsinki (FI)

(72) Inventors: Esa NUMMIJOKI, Seinäjoki (FI); Ville PIIPPO, Helsinki (FI); Tuomo LEHTIMÄKI, Seinäjoki (FI)

(73) Assignee: VERGE MOTORCYCLES OY, Helsinki (FI)

(21) Appl. No.: 18/843,601

(22) PCT Filed: Mar. 3, 2023
(86) PCT No.: PCT/FI2023/050123

§ 371 Date: Sep. 3, 2024

(30) Foreign Application Priority Data
Mar. 4, 2022 (FI) 20225194

(51) Int. Cl. H02K 1/2791; B62M 7/12; H02K 1/18; H02K 21/22

(52) U.S. Cl. CPC H02K 1/2791; H02K 1/187; H02K 21/22; B62M 7/12

(57) ABSTRACT

A rotor for an electric motor includes a rotor core defining recesses extending in a width direction on a surface of the rotor core. Each of the recesses includes at least one interlocking element. The rotor further includes support members, each of which extends in the width direction in one of the recesses and is supported by the corresponding interlocking element. At least some of the support members extend beyond an edge of the rotor core in the width direction.

### FIELD OF THE INVENTION

The present invention relates in general to electric motors. In particular, however not exclusively, the present invention concerns rotors, particularly cores thereof, of electric motors used in electric motorcycles, and the electric motorcycles.

### BACKGROUND

In electric motorcycles, the weight of the motorcycle is of utmost importance since, when compared, for example, to electric cars, the space for batteries is even more limited. Thus, in order to provide sufficient driving range, the electric motorcycle should be otherwise as lightweight as possible so that all possible space for batteries can be utilized without the motorcycle becoming too heavy.

One component which adds weight is the electric motor of the motorcycles. Thus, it is desirable to make the electric motor as light and compact as possible, however, without making compromises in the power rating and robustness.

### SUMMARY

An objective of the present invention is to provide a rotor for an electric motor, an electric motor, and an electric motorcycle. Another objective of the present invention is that the rotor, the electric motor, and the electric motorcycle at least alleviate some of the drawbacks in the known solutions, for example, provide an electric motor which is lighter but still efficient.

The objectives of the invention are reached by a rotor for an electric motor, an electric motor, and an electric motorcycle as defined by the respective independent claims.

According to a first aspect, a rotor for an electric motor is provided. The rotor comprises a rotor core defining a plurality of recesses extending in a width direction on a surface of the rotor core, wherein each one of the recesses includes at least one interlocking element, such as, as an integrated portion of the rotor core. Furthermore, the rotor comprises a plurality of support members, each one of which extends in the width direction in one of the recesses and is supported by the corresponding interlocking element, wherein at least some of the plurality of support members extend beyond an edge of the rotor core in the width direction.

The rotor core may be made of steel sheets stacked upon each other. Preferably, the interlocking element(s) may be (an) integrated portion(s) of one or more of the steel sheets.

Furthermore, the rotor may comprise a plurality of permanent magnets arranged on the opposite side of the rotor core relative to the recesses. Furthermore, each one of the plurality of permanent magnets may be arranged to a corresponding position relative to one of the recesses, respectively.

In various embodiments, the recesses may extend into the rotor core a first distance being at least 0.30, 0.35, 0.40, 0.45, or even 0.5 or more even up to 0.8 or 0.9, times a height of intermediate portions of the rotor core between two adjacent ones of the recesses.

In some embodiments, each one of the plurality of permanent magnets may be wider than the recesses at the corresponding position at their base in a perpendicular direction relative to the width direction.

Furthermore, at least portion of an edge of the recesses may be curved or has an arc shape starting from an edge of the base and continuing towards bottom of the recess.

In some embodiments, the rotor core is discontinuous in the recess on the opposite side of the plurality of support members relative to the rotor core.

The plurality of support members may be arranged completely into the recesses in a thickness direction of the rotor core.

The rotor may be adapted to be arranged outside a stator of the electric motor, that is as an outer rotor.

According to a second aspect, an electric motor is provided. The electric motor comprises a rotor and a stator comprising a stator core and one or more motor windings arranged for providing an electromagnetic coupling between the rotor and the stator. The rotor is in accordance with the first aspect.

Furthermore, the rotor may comprise, on the opposite side of the rotor core relative to the recesses, a plurality of permanent magnets facing the plurality of stator teeth.

In various embodiments, a height of a rotor core of the rotor is 0.7-1.3, preferably about 1.0, of the height of intermediate portions of the stator core.

The motor may comprise a support element arranged in contact with the stator core on the opposite side of the stator core relative to the plurality of stator teeth, wherein the support element comprises protrusions on a surface thereof at corresponding positions with respect to the recesses of the stator core, wherein the protrusions are adapted so that they fit into the recesses and provide interlocking between the support element and the stator core, preferably by the opposite sides surfaces of the recesses being very close to, such as being less than 0.5 millimeter away from, or, even more preferably, in contact with corresponding opposite side surfaces of the protrusions.

In some embodiments, the support element may be arranged so that the protrusions are completely in the recesses, and a surface portion of the support element facing the stator core and between the protrusions is in contact against the corresponding surface of the stator core.

According to a third aspect, an electric motorcycle is provided. The electric motorcycle comprises an electric motor in accordance with the second aspect, wherein the electric motor is arranged to rotate at least one wheel of the electric motorcycle.

The present invention provides a rotor for an electric motor, an electric motor, and an electric motorcycle. The present invention provides advantages over known solutions in that it provides light and yet efficient electric motor and an electric motorcycle utilizing the motor.

Various other advantages will become clear to a skilled person based on the following detailed description.

The expression “a number of”' may herein refer to any positive integer starting from one (1), that is being “at least one” or “a plurality of”.

The expression “a plurality of” may refer to any positive integer starting from two (2), that is being “at least two”.

The terms “first”, “second” and “third” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in depending claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically an outer rotor for an electric motor.

FIG. 2 illustrates schematically an inner rotor for an electric motor.

FIGS. 3A-3C illustrate schematically a rotor for an electric motor.

FIG. 4 illustrates schematically an electric motor.

FIGS. 5A-5C illustrate schematically electric motors.

FIG. 6 shows an example of magnetic flux flow during use of an electric motor.

FIGS. 7A and 7B illustrate schematically portions of a stator core of an electric motor.

FIG. 8 illustrates schematically an electric motor.

FIG. 9 illustrates schematically support members on a rotor.

FIGS. 10A and 10B illustrate schematically an electric motor.

FIG. 11 illustrates schematically an electric motor.

FIG. 12 illustrates schematically an electric motor.

FIG. 13 illustrates an electric motorcycle.

### DETAILED DESCRIPTION OF SOME EMBODIMENTS

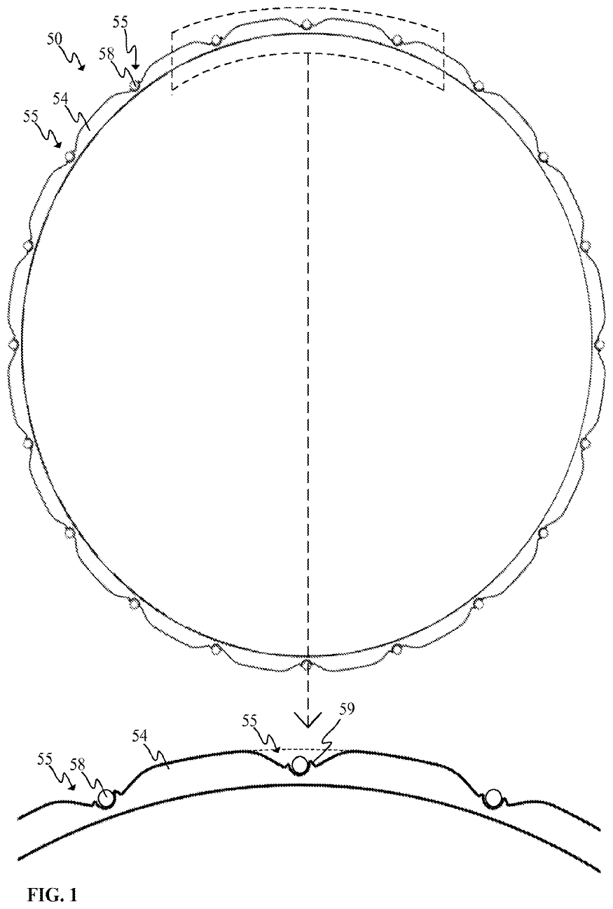

FIG. 1 illustrates schematically a rotor 50, particularly an outer rotor, for an electric motor. In motors with an outer rotor, a stator is arranged inside the outer rotor. In the top part of FIG. 1, the whole rotor is shown with a cross section view of one position thereof. In the bottom part of FIG. 1, the portion marked with dashed line in the top part is shown as enlarged. The rotor 50 comprises a rotor core 54 defining a plurality of recesses 55 extending in a width direction on a surface of the rotor core 54. Each one of the recesses 55 includes at least one interlocking element 59, such as being integrated with the rotor core 54 or a separate element being attached to the surface of the rotor core 54. Furthermore, the rotor 50 comprises a plurality of support members 58, such as pipes, screws, pegs, or the like longitudinal elements, each one of which extends in the width direction in one of the recesses and is supported by the corresponding interlocking element 59. At least some of the plurality of support members 58 extend beyond an edge of the rotor core 54 in the width direction. This is more visible, for example, in FIG. 9.

In various embodiments, the rotor core 54 is made of steel sheets being stacked on top of each other.

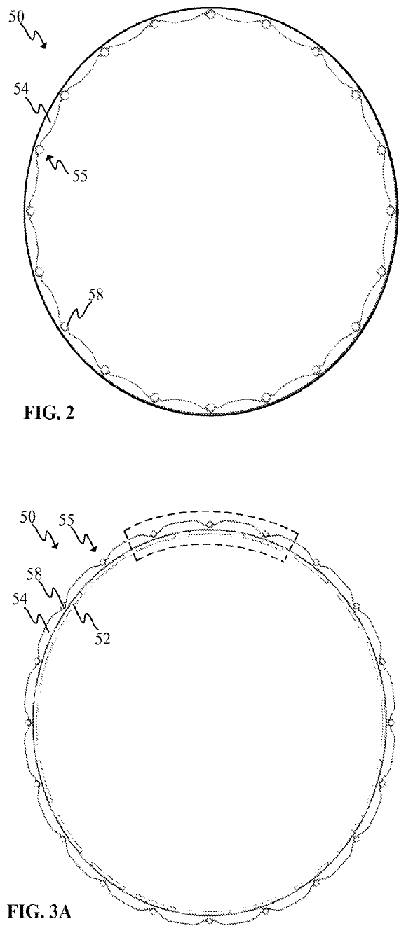

FIG. 2 illustrates schematically a rotor 50, particularly an inner rotor, for an electric motor. In motors with an inner rotor, a stator is arranged outside or around the outer rotor. As can be seen, the structure of the rotor 50 is similar to the one shown in FIG. 1, however, the rotor 50 is intended to be used as an inner rotor, that is, the rotor 50 is adapted to receive a stator around it. In this case, as visible, the support members 58 and the interlocking elements 59 are on the inner side of the rotor 50.

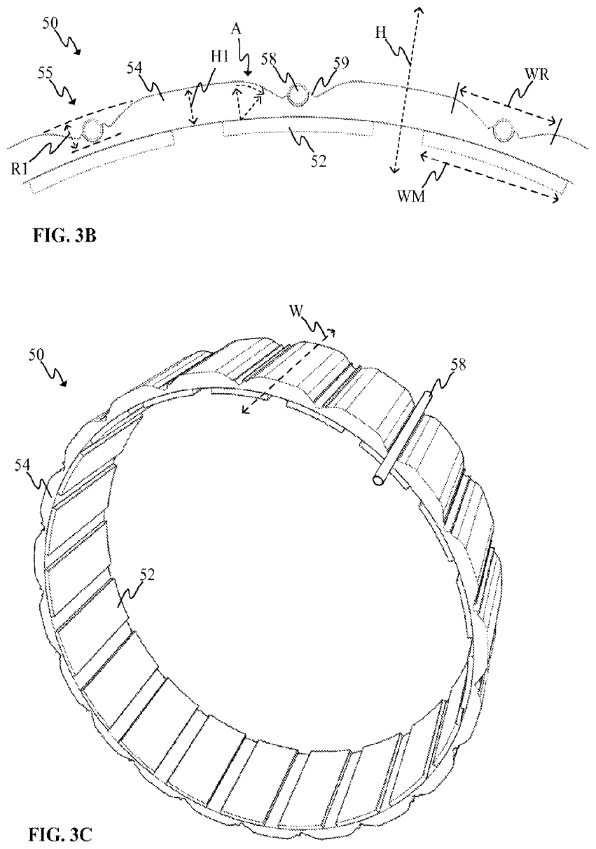

FIGS. 3A-3C illustrate schematically a rotor 50 for an electric motor. This case too, the rotor 50 is an outer rotor, such as in FIG. 1. FIG. 3A shows a cross-section of the rotor 50, FIG. 3B an enlargement of a portion of the rotor 50, and FIG. 3C the rotor 50 from a perspective view. In FIG. 3C, the width direction W of the rotor 50 is shown. FIG. 3A is substantially similar to FIG. 1, however, shows a plurality of permanent magnets 52 arranged on the opposite side of the rotor core 54 relative to the recesses 55. In preferable embodiments, each one of the plurality of permanent magnets 52 is arranged to a corresponding position relative to one of the recesses 55, respectively.

FIG. 3B shows some dimensions of various elements of the rotor 50. The thickness or height of an intermediate portion of the rotor core 54 is marked with H1. The intermediate portion refers to the portion of the rotor core 54 between two adjacent recesses 55. Furthermore, the recesses 55 may extend into the rotor core 54 by a first distance R1 being at least 0.30 times the height H1 of intermediate portions. In FIG. 3B, the first distance R1 is in fact, over 0.50 times the height H1. In some embodiments, the first distance may be in the range of 0.30 to 0.75.

As can further be seen in FIG. 3B, each one of the plurality of magnets 52 may be wider than the recesses 55 at the corresponding position at their base in a perpendicular direction relative to the width direction W. The width of a permanent magnet 52 is shown in FIG. 3B with reference sign WM and the width of a recess 55 at its base with reference sign WR. Thus, the intermediate portions on both sides of the recess 55 overlap with the permanent magnet 52.

FIG. 3B also more clearly shows one example of the interlocking element 59. The interlocking element 59 is, in this case, a protrusion or “claw” that extends slightly around the support member 58. The interlocking element 59 thus holds the support member 58 so that it doesn't become unattached from the rotor core 54. The support member 58 may have been slid into its position from the side of the rotor core 54, that is, sliding it into direction towards (or away) the viewer in FIG. 3B.

Still further related to the structure of the rotor 50, FIG. 3B shows at A that at least portion of an edge of the recesses 55 may be curved or has an arc shape starting from an edge of the base and continuing towards bottom of the recess 55.

In various embodiments, the rotor core 54 may be discontinuous in the recess 55 on the opposite side of the plurality of support members 58 relative to the rotor core 54. Thus, there is also no magnetic material extending on the opposite side of the plurality of support member 58 relative to the rotor core 54. The magnetic flux during the use of the motor thus flows mainly, if not completely, via the rotor core 52 between the support members 58 and the permanent magnets 52.

In various embodiments, the plurality of support members may be arranged completely into the recesses 55 in a thickness direction H of the rotor core 54. Thus, for example, the rotor 55 may be easily arranged inside a cylindrical object. For example, on the opposite side of the cylindrical object may then be arranged a tire or the like, if the motor is utilized in a motorcycle.

The rotor core 52 of the rotor 50 may comprise or is of magnetic material, such as of ferromagnetic material, e.g., including or substantially consisting of iron. In addition, or alternatively with respect to the material being magnetic material and/or the rotor core 52 having height of 0.7-1.3 of the intermedia portions 17 as described above, the rotor core 52 or some other part of the rotor 50, comprises support members 58. The support members 58 may be, for example, pipes, poles, rods, such as of metal, or the like elongated objects which are attached to interlocking shapes 59 on the surface of the rotor core 52 or the rotor 50. The elongated shape is not visible in FIGS. 3A and 3B since the support members 58 extend towards and/or away from the reader. The elongated nature is better seen in FIG. 3C. The interlocking shapes 59 may be small protrusions, or “claws”, which support the support members 58. Thus, the members 58 may be, for example, arranged to their position from one side of the motor 100, that is sliding them into their positions in the direction of the elongated shape, said direction being perpendicular to the direction of the rotation of axis of the motor 100.

In some preferable embodiments, the rotor core 52, being of magnetic material, may comprise the interlocking shapes 59, either as integrated, or separate attached portions, that is “interlocking elements”, being such that they do not extend around the support members 58. Thus, there is no low reluctance path for the magnetic flux around the support members 58 on the outer side, that is the opposite side with respect to the magnets 52, of the rotor core 54. Thus, the magnetic flux flows mainly, if not substantially completely within the rotor core 54 on the side of the magnets 52. The support members 58 provide thus a way to align the sheet metals, if any, of the rotor core 54. However, in some embodiments, there is a further effect that the support members 58 provide. In these embodiments the support members 58 extends farther than the rotor core 54. Thus, the ends of the second support members 58 extending beyond the rotor core 52 may be utilized for coupling the rotor 50 to other structures, such as of an electric motorcycle.

FIG. 4 illustrates schematically an electric motor 100. The electric motor 100 comprises a rotor 50 which is similar to one shown in FIGS. 3A-3C. FIG. 4 also illustrates a stator 40. The stator comprises a stator core 10 comprises or is of magnetic material, such as of ferromagnetic material, for example, including or being of iron, and defines, or essentially consists of, a plurality of stator teeth 12 and a stator yoke 14. The stator core 10 also, preferably, defines stator slots 18 into which winding(s) of the motor 100 can be arranged.

The winding(s) may be arranged so that there are coils of winding(s) provided, such as wound, around each one of the stator teeth 12. Thus, the current applied to the winding(s) and thus flowing in the coil(s) generates a magnetic field as is known to a skilled person in the art. The magnetic flux thus flows via the stator yoke 14 and into/out of the stator teeth 12. Naturally, there is arranged an air gap between the rotor 50 and the stator 40 so that they can move, that is rotate, relative to each other.

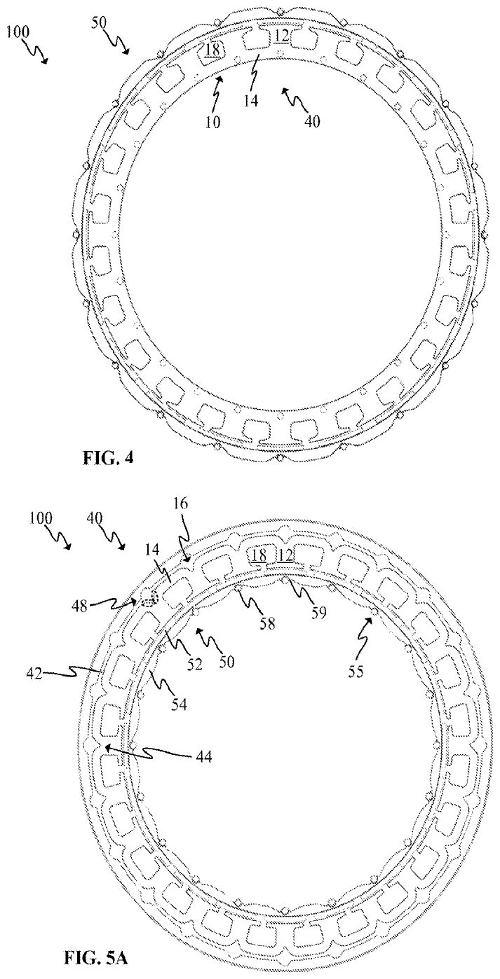

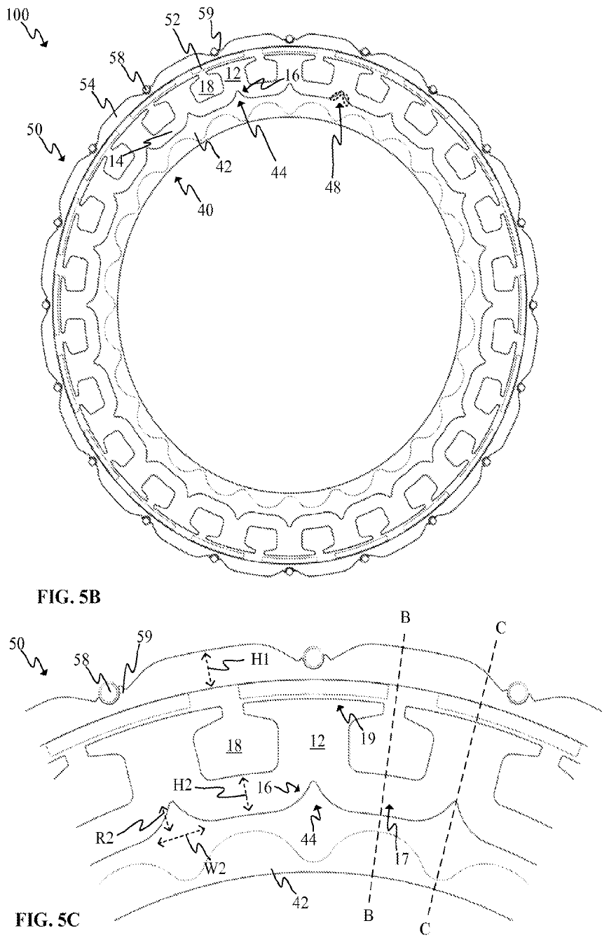

FIGS. 5A-5C illustrate schematically electric motors 100. FIG. 5A illustrates a motor 100 with a rotor 50, which is an inner rotor. On the other hand, FIGS. 5B and 5C shows a rotor 50 which is an outer rotor. Furthermore, in each of FIG. 5A-5C, the stator 40 may comprise the stator yoke 14 comprising recesses 16 at corresponding positions relative to most of the plurality of teeth 12, the recesses 16 being on the opposite side of the stator yoke 14 relative to the plurality of teeth 12. Furthermore, alternatively or in addition, even though the recesses 16, or grooves, may extend over the whole width of the stator core 10, that is in the longitudinal direction of the stator slots 18, the recesses 16 may as well extend only in a portion of the width of the stator core 10. Thus, the recess 16 may be discontinuous in said direction and, thus, not defining a continuous groove over the whole width. In preferable embodiments, the recess 16 does extend over the whole width or at least over a half of the width. FIG. 5C also indicate the intermediate potions 17 of the stator core 10. The intermediate portion(s) 17 of the stator 40 refer(s) herein to the portion(s) of the stator yoke 14 which extend between two adjacent stator teeth 12.

Even though the stator core 10 has been shown as a single-piece stator core 10, in various embodiments, the stator core 10 may, alternatively, be manufactured by a plurality of sheet metals, preferably, of ferromagnetic material. The sheet metals may thus be arranged adjacent to each other in the direction of the width of the stator core 10, that is in the longitudinal direction of the stator slots 18, for instance, such as in case of the rotor 50.

The recesses 16 extend into the stator yoke 14 in a longitudinal direction of the corresponding stator tooth 12 a second distance R2. In various preferable embodiments, the second distance R2 may be at least 0.2 times a height H2 of intermediate portions 17 of the stator yoke 14 between adjacent teeth of the stator teeth 12.

The stator core 10 which is arrangeable as a part of an interior stator around which an exterior rotor can be arranged to rotate relative to the interior stator in the electric motor 100, such as discussed hereinbefore.

In some embodiments, the recesses 16 may extend towards the plurality of teeth 12 at most so that there is at least a distance between a tip 19 of the stator teeth 12 and the bottom of the recess 16, wherein the distance is about equal to the height H1 of the intermediate portions 17 of the stator yoke 14. In some other embodiments, the second distance R2 may be at most 1.5 times or less than the height H2 of intermediate portions 17 of the stator yoke 14 between adjacent teeth of the stator teeth 12.

In various embodiments, a width W2 of the recesses 16 at their base may be at least 0.75 times a width of the plurality of stator teeth 12. The base as referred hereinabove refers to a position where the recess 16 starts, that is, having regard to the surface portions of the stator core 10 adjacent to the recess 16 on the opposite side of the stator yoke 14 relative to the stator teeth 12.

Preferably by the opposite sides surfaces 32 of the recesses 16 are arranged to be very close to, such as being less than 0.5 millimeter away from, or, even more preferably, in contact with corresponding opposite side surfaces 48 (indicated with ellipses which are drawn with dashed lines in FIG. 5A) of the protrusions 44 in order to provide tight enough interlocking between the support element 42 and the stator core 10.

In various embodiments, the support element 42 may be arranged so that the protrusions 44 are completely in the recesses 16, and a surface portion of the support element 42 facing the stator core 10 and between the protrusions 44 is in contact against the corresponding surface of the stator core 10. This can maximize the surface areas of the stator core 10 and the support element 42 which come into contact with each other. The protrusions 44 may, when being arranged into the recesses 16, completely fill the recesses 16 or the protrusions 44 may reside in the space defined by the recesses 16, however, do not fill the space completely. There may be, for example, the bottom of the recesses 16 left unfilled. The protrusions 44 that are only partly filling the recesses 16 provide some tolerance for arranging the support element 42 in contact with the stator core 10 so that the surface portion of the support clement 42 facing the stator core 10 and between the protrusions 44 is in contact against the corresponding surface of the stator core 10 for maximizing the surface areas in contact with each other.

In addition, the support element 42 may provide thermal management, such as cooling, for the stator core 10 since the heat generated in the stator 40 can be moved from the stator core 10 to the support element 42 by thermal conduction. Thus, in various embodiments, the support element 42 may be of thermally conductive material, such as comprising or being of aluminum. This also facilitates reducing mass of the electric motor 100 since the support element 42, which provides support for the stator core 10 as well as optionally enables attaching the motor 100 to, for example, a motorcycle, made of aluminum is lightweight and at the same time provides cooling of the stator 40 of the motor 100. The inner portion of the motor 100, that is inside the inner edge of the support element 42 may be empty or there may be some other elements arranged thereto.

The stator 40 may comprise a support element 42 arranged in contact with the stator core 10 on the opposite side of the stator core 10 relative to the plurality of stator teeth 12. The support element 42 preferably comprises protrusions 44 on a surface thereof at corresponding positions with respect to at least most of the recesses 16 of the stator core 10. Thus, the number of protrusions 44 may be at most equal or less than the number of recesses 16. The protrusions 44 may be adapted so that they fit into the recesses 16 and provide interlocking between the support element 44 and the stator core 10.

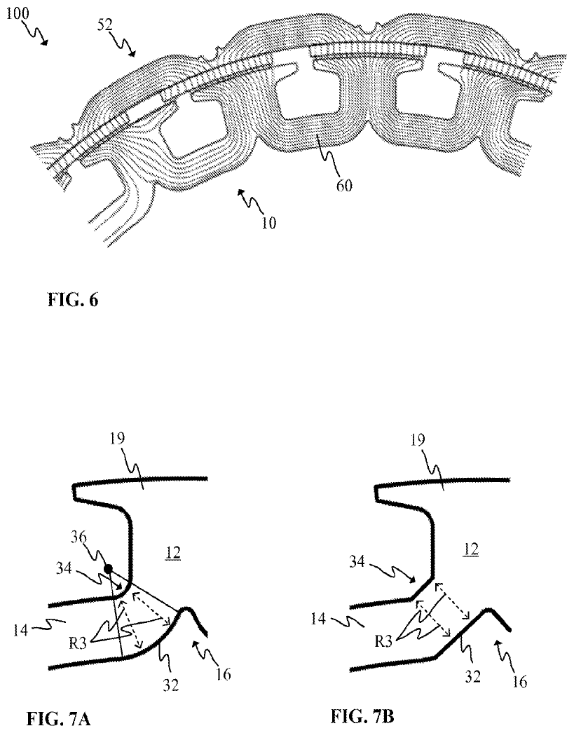

FIG. 6 shows an example of magnetic flux flow during use of an electric motor 100. As can be seen, the motor 100 (or the part thereof shown in FIG. 6), with respect to its rotor core 54 and the stator core 10. Also, the motor 100 is similar than shown in FIGS. 5B and 5C, for instance. Still further, the magnetic flux acts in similar manner also in the interior rotor motor shown in FIG. 5A, although relative positions and dimensions etc. are different.

As can be seen, in FIG. 6, the magnetic flux 60 is uniform especially when a magnet 52 and a stator tooth 12 align with each other. However, the magnetic flux 60 tend to be rather uniform and the stator and rotor core material efficiently utilized also when there is misalignment with a permanent magnet 52 and a stator tooth 12. As can be seen, different aspect described in connection with FIG. 3B herein provide advantages to the flow of magnetic flux 60, such as the arc shape or curved edge close to the recesses 55, the width of the permanent magnets 52 compared to the recesses 55, and/or that there is not rotor core 54 extending in the recesses 55 on the opposite sides of the support members 58 relative to the permanent magnets 52 and/or the stator 40.

As visualized in FIG. 6, the recesses 16 of stator yoke 14 do not interfere the flow of magnetic flux, however, they do make the stator core 14 less heavy since material is omitted from the recesses 16. As stated hereinafter, the space of the recesses 16 may then be at least partially filled with lighter material of the support element 42 which may be non-magnetic and lightweight material, such as aluminum. Thus, the motor 100 can be made lighter by an amount comparable to the volume of material having higher density, such as iron, being removed/omitted from the stator core 10 to form the recesses 16, and being at least partially replaced by less dense material of the support element 42, such as aluminum, defining the protrusions 44.

Furthermore, in some embodiments, the rotor 50 may additionally be dimensioned such as in FIG. 6, that is, to have the height H1 of a magnetic rotor core 54 substantially similar relative to the height H2 of the intermediate portions 17 of the stator core 10. Further still, optionally, there may be the second support members 58 (not shown in FIG. 6) coupled to the rotor core 54 by the interlocking shapes 59.

FIGS. 7A and 7B illustrate schematically portions of stator cores 14 for electric motors 100. A shape of side surfaces 32 of the recesses 16 may, preferably, correspond to a shape of inner corners 34 of adjacent stator slots 18, thereby providing substantially uniform height profile of the stator yoke 14 at the intermediate portions 17 and the portions defined by the side surface 34 of the recesses 16 and the inner corners 32 of adjacent stator slots 18, that is said portions residing substantially therebetween.

In FIG. 7A, the inner corners 34 have mostly an arc shape defined by a first radius of rotation and the side surface 32 of the recesses 16 has mostly an arc shape defined by a second radius of rotation, wherein the first radius of rotation and the second radius of rotation have the same axis of rotation and the first radius is longer than the second radius by the second distance.

In FIG. 7B, the inner corners have a planar shape which is inclined with respect to a longitudinal direction of the closest stator teeth, wherein the side surface of the recesses 16 has also a planar shape which is parallel with the closest inner corner.

In FIGS. 7A and 7B, a third distance R3 between the side surface 32 of the recesses and the inner corners 34 of adjacent stator slots may be 0.7-1.3, preferably about 1.0, of the height H2 of the intermediate portions 17 of the stator core 10, thereby providing substantially uniform height profile of the stator yoke 14 at the intermediate portions 17 and the portions defined by the side surface 34 of the recesses 16 and the inner corners 32 of adjacent stator slots 18, that is said portions residing substantially therebetween.

In various embodiments, a width W2 of the plurality of stator teeth 12 may be in the range of 1.5-2.5, preferably about 2.0, of a height H2 of the intermediate portions 17 of the stator yoke 14 between adjacent stator teeth 12, thereby providing substantially uniform height profile of the stator yoke 14 at the intermediate portions 17 and the plurality of stator teeth 12 in view of the magnetic flux during use of the motor which comprises the stator core 10 as described hereinbefore.

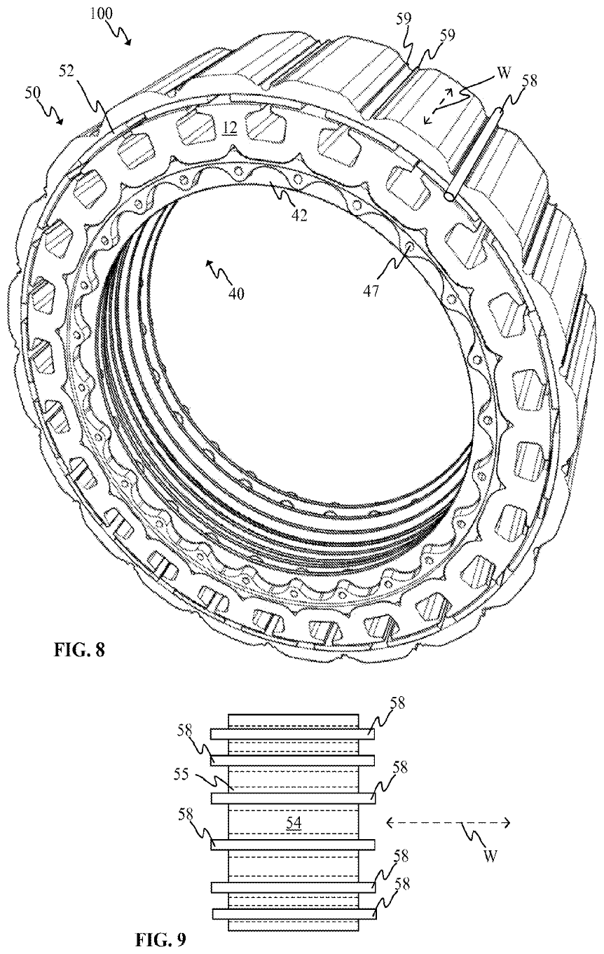

FIG. 8 illustrates schematically an electric motor 100 as a perspective view. The stator 40, and especially the stator core 10 are identical to the one shown in and described in connection to FIGS. 5B and 5C. Regarding especially FIG. 8, the inner side of the support element 42 comprises, such as defines as an integral portion of the element 42, cooling fins. Thus, the support element 42 may in this case operate as a heat sink of the motor 100.

Still further, the support element 42 may comprise at least one, preferably, a plurality of, hole for screws or other such attachment means. Thus, the motor 100 may comprise a stator core 10 which is mechanically interlocked to the support element 42 by the recesses 16 and corresponding protrusions 44, and the support element 42 may then be further attached to other structures of, for example, the electric motorcycle or other parts of the motor 100 itself.

FIG. 9 illustrates schematically support members 58 on a rotor 50. FIG. 9 is a side view of the rotor 50 from outside the rotor 50, such as of a similar rotor 50 than in FIG. 8. The edges of the recesses 55 are shown with dashed lines. As can be seen, there may be support members 58 arranged into the recesses 55 and being held in place by the interlocking elements 59 (not shown in FIG. 9). Furthermore, the plurality of support members 55 extend in the width direction W beyond an edge of the rotor core 54 in the width direction W. Thus, as will be shown and explained, the support members 58 can be gripped by another clement of the ends of the support members 58 extending beyond the rotor core 54. The attaching of the rotor 50 to other structure can, thus, be made via the ends of the support members 58. The rotational force provided by the motor 100 may be transmitted from the rotor 50 via the support members 58 to the structure having, for example, a tire or other friction surface which is to be in contact with external surfaces, such as in a wheel of a motorcycle or the like. Naturally, other applications are also possible.

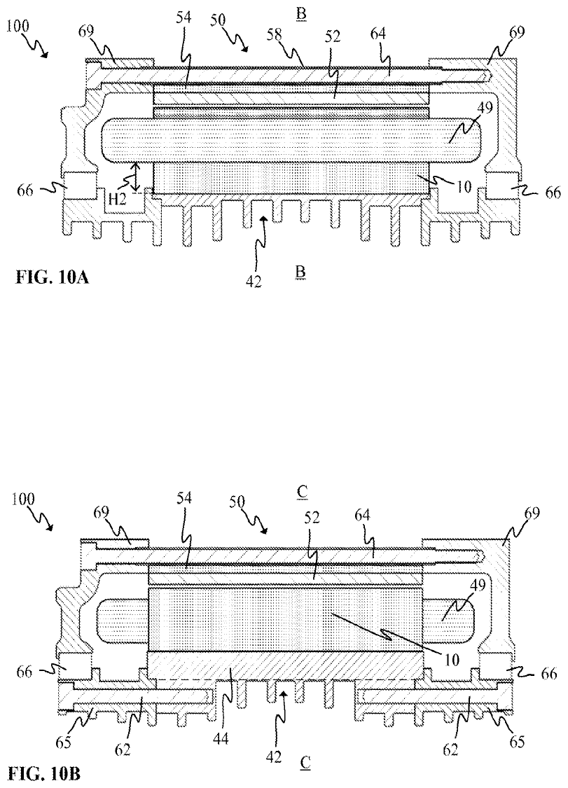

FIGS. 10A and 10B illustrate schematically an electric motor 100. FIGS. 10A and 10B show cross-sectional views of the motor 100 at two different positions, namely at B and C. These positions, that is “B” and “C” are illustrated in FIG. 5C which show similar, however, not necessarily identical, motor 100 as the one shown in FIGS. 10A and 10B. Basically, position “B” is between two adjacent stator teeth 12 and position “C” is approximately in the middle of a stator teeth 12, at the position of the corresponding recess 16. Thus, cross-sectional views of the motor 100 in FIGS. 10A and 10B are shown in the direction perpendicular relative to the direction in which the motor 100, or at least portion(s) thereof, is shown in FIGS. 5A-5C, for instance.

In FIG. 10A, the cross-sectional view is taken at the stator slot 18 between two stator teeth 12. FIG. 10A thus shows a cross section of a winding 49 or at least coil 49 thereof. As can be seen, the height H2 of the stator core 10 at the intermediate portion 17 thereof is shown in the figure. In FIG. 10B, on the other hand, the height or thickness of the stator core 10 corresponds to the height or the thickness of the stator core 10 at a stator tooth 12. In FIG. 10B, the support element 42 thus extends higher than in FIG. 10A because in this particular case, in accordance with various embodiments, one of the protrusions 44 of the support element 42 is visible.

In some embodiments, even if FIG. 10B shows that the recess 16 and the corresponding protrusion 44 extend over the whole width of the stator core 10, there may be portions in which there are no the recess 16 and the corresponding protrusion 44. Thus, the recess 16 may be discontinuous and/or extend only in part, or sub-portion, of the stator core 10. In various preferable embodiments, the recess 16 extends at least at one of the edges of the stator core 10 so that the support element 42 can be arranged, such as slid, into its place inside the stator core 10, or vice versa so that that the stator core 10, or the plurality of sheet metals thereof, can be arranged on to the support element 42.

In various preferable embodiments, the protrusions 44 may thus be utilized to align the sheet metals, if any, of the stator core 10, if the protrusions 44 and the recess 16 extend substantially through the stator core 10 and the support element 42 in the width direction thereof.

In various embodiments, as visible in FIGS. 10A and 10B, the support element 42 may comprise or define a heat sink structure with, for example, cooling fins on the opposite side of the support element 42 relative to the stator core 10. Thus, heat generated in the motor 100 can be efficiently conducted out of the motor 100 via the fins, especially if the support element 42 is, as described hereinbefore, of thermally conductive material, such being of or at least comprising metal.

Furthermore, the support element 42, such of aluminum or copper or the like, can be comprised of a plurality of parts, as visible in FIGS. 10A and 10B.

Still further, the support element 42 may be attached by stator attachment means 62, such as by screws of the like, to other portions of the motor 100 and/or, optionally, a motorcycle.

In both of FIGS. 10A and 10B, the cross-sectional view is taken at the position of the support members 58. The support members 58 are, in this case, pipes or the like elongated objects, which are attached to interlocking shapes 59 or elements on the surface of the rotor core 52 or the rotor 50, and through which optional rotor attachment means 64 are arranged so that the rotor 50 is attached to other parts of the motor 100 and/or, for example, a motorcycle. What is noticeable (marked with a thicker line in FIGS. 10A and 10B), the support members 58 extend farther than the rotor core 54. Thus, the ends of the support members 58 can be utilized for attaching the rotor 50 to other portions of the motor 100 and, for example, the motorcycle.

Further still, with reference to FIGS. 10A and 10B, there may be further bearing and/or scaling members 66 arranged between the rotor 50 and the stator 40 which allow the rotor 50 and the stator 40 move relative to each other. Furthermore, there may, as also referred to hereinbefore by “other portions”, rotor side portions 69 and stator side portions 65 between which the bearing and/or sealing members 66 may be arranged to. The rotor side portion 69 and the stator side portion 65 are, preferably, arranged to be rotatable relative to each other. Furthermore, the stator side portion 65 may also include cooling fins on the opposite side of the stator side portion 65 relative to the rotor 50.

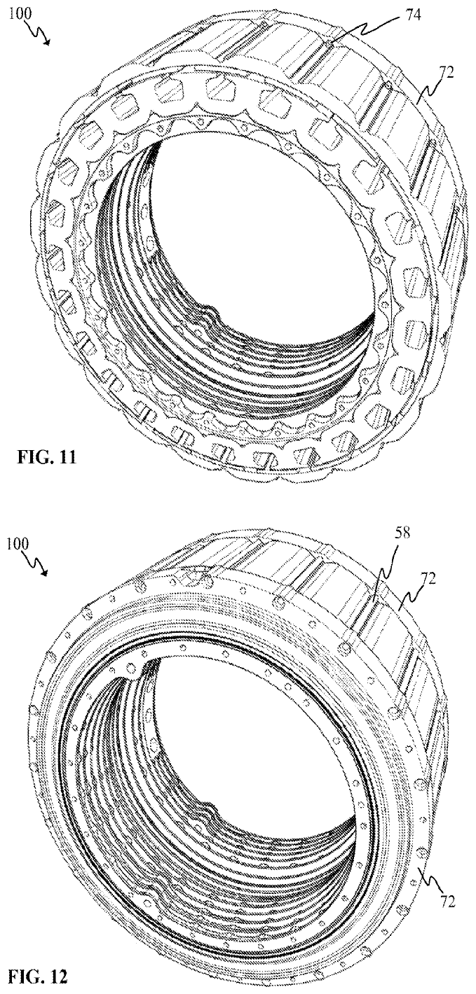

FIG. 11 illustrates schematically an electric motor 100. The electric motor 100 is shown as a perspective view. The motor 100 furthermore comprises a side part 72. The side part 72 may be comprised of such elements/parts as shown in FIGS. 10A and 10B, that is stator side portion 65 and rotor side portion 69, and, optionally, the bearing and/or sealing member 66 therebetween. Furthermore, the side part 72 may include, such as shown in FIGS. 7A and 7B, side portion attachment means for attaching the side part 72 to one side of the motor 100. The side part 72 may advantageously enclose the ends of the one or more windings 49 between the side part 72 and the stator core 10.

In various embodiment, the side portion 72 comprises holes 74 or recesses 74 or other such shapes for receiving one end of the support members 58. In FIG. 11, the support members 58 are omitted so that the holes 74 or the recesses 74 are visible. As can be realized, the end of the support member 58 extending farther than the edge of the stator core 10 may thus be arranged to the corresponding hole 74 or recess 74. This way the rotor 50 may be coupled to the side part 72 for rotating at least portion of the side part 74 together with the rotor 50. Furthermore, as the holes 74 or the recesses 74 may be made deeper than the end of the support members 58, the tolerances for manufacturing the holes 74 and the support members 58 becomes may be larger since the coupling to the side part 72 occurs in the direction of the rotation, that is based on outer side surface(s) of the support members 58 and inner side surface(s) of the holes 74 or recesses 74.

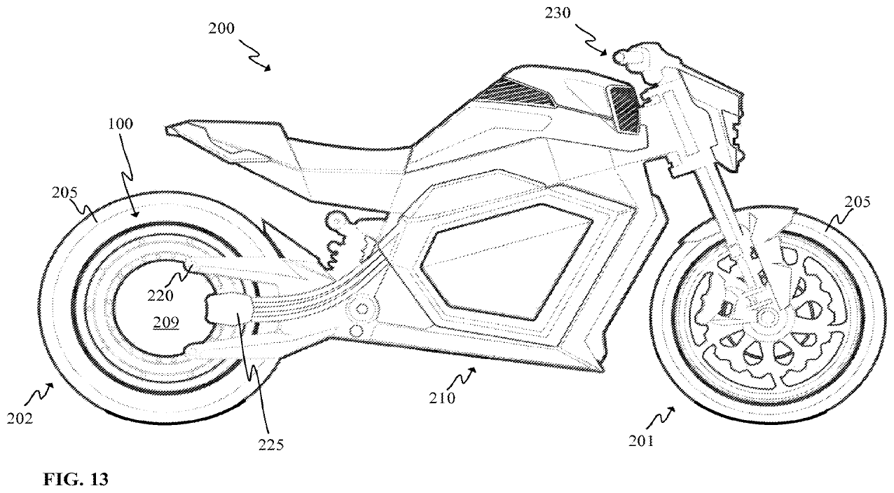

FIG. 12 illustrates schematically an electric motor 100. The electric motor 100 is shown as a perspective view. The motor 100 is identical to the one shown in FIG. 11, however, the motor 100 further comprises another side part 72 on the opposite side of the motor 100 relative to the first side part 72. Said another side part 72 may be essentially identical relative to the first side part 72, or they may differ to some extent. FIG. 12 shows the second support members 58 being arranged to the grooves and having their ends arranged to the holes 74 or recesses 74. As can be seen in FIG. 12 (also in FIGS. 10A and 10B), there may be openings in the side part 72 for arranging through them the support members 58, and/or stator and/or rotor attachment means 62, 64. FIG. 13 illustrates an electric motorcycle 200. The rotor 50 and/or the electric motor 100 in accordance with at least one of the embodiments as described hereinbefore may be utilized in the motorcycle 200, such as in connection with at least the rear wheel 202 thereof as shown in FIG. 13. Thus, the electric motor 100 may be arranged to rotate at least one wheel, such as the rear 202 and/or the front wheel 201, of the electric motorcycle 100. In some embodiment, the motorcycle 200 may comprise two motors 100, each one of them arranged to a different wheel of the wheels 201, 202.

In various embodiments, the electric motor 100, such as the outer side rotor 50 thereof, may be arranged to accommodate a tire, such as a rubber tire, on the outer surface thereof. Thus, the electric motor 100 may function as a rim for the motorcycle 100. In some other embodiments, the electric motor 100 may comprise a rim attachment element arranged around the rotor 50, for instance, to which, such as outside of which, the rim having the tire is then attached. In these cases, the motor 100 may easily be detached from the rim attachment element for maintenance or replacement.

In various embodiments, such as shown in FIG. 13, there may be an inner empty space 209 defined by the motor 100.

Furthermore, the electric motorcycle 200 may comprise one or several electrical energy storage elements 210, such as batteries, for providing electrical storage for driving the motorcycle 200. The one or several electrical energy storage elements 210 may be arranged inside the body, such as attached to a frame, of the motorcycle 200.

In various embodiments, the electric motorcycle 200 may comprise a rear swing arm 220 for suspending the rear wheel 202 thereon. There may also be suspension arranged in connection with the rear swing arm 220 which may be pivotally arranged to the body of the motorcycle 200.

In some embodiments, the rear swing arm 220 may be attached to the electric motor 100 on both sides or at least on one side. The attachment is thus arranged to carry the load between the electric motor 100 and the rest of the motorcycle 200. In FIG. 13, there is shown a rear swing arm 220 which is attached to the electric motor 100, in some embodiments to a side part 72 thereof, with screws or the like. The attachment may be provided on both sides. Furthermore, the rear swing arm 220 is preferably attached to the motor 100 at at least two positions in the vertical direction such as shown in FIG. 13.

Furthermore, the electric motorcycle 200 may comprise a connector 225 for connecting the electric motor 100 to other electrical devices of the motorcycle 200, including the electric energy storage elements 210. Still further, the motorcycle 200 may comprise an electric converter unit (not shown), such as including an inverter, for operating the motor 100.

In addition, the electric motorcycle 200 may comprise a steering mechanism 230 for turning, for example, the front wheel 201. The steering mechanism 230 may comprise a handlebar comprising a speed adjusting means or element, such as a rotatable handle, button, level, knob, or the like, for controlling the speed of the electric motor 100 and, thereby, the speed of the motorcycle 200. Thus, the speed adjusting means or element may be functionally connected to the electric converter unit for providing a set value for controlling the movement of the motorcycle 200.

In various embodiments, being separate or integrated into the converter unit, the electric motorcycle 200 may comprise a controller (not shown) comprising at least one processing unit and memory device. The controller may be configured to implement control functions of the motorcycle 200, such as related to driving, safety, lighting, etc. Various sensors, such as speed and/or acceleration sensors, related to the operation of the motor 100 and/or the motorcycle 200 may be arranged in connection with the controller.

1. A rotor for an electric motor, comprising:
a rotor core defining a plurality of recesses extending in a width direction on a surface of the rotor core, wherein each one of the recesses includes at least one interlocking element, and
a plurality of support members, each one of which extends in the width direction in one of the recesses and is supported by the corresponding interlocking element, wherein at least some of the plurality of support members extend beyond an edge of the rotor core in the width direction.

2. The rotor of claim 1, wherein the rotor core is made of steel sheets stacked upon each other.

3. The rotor of claim 1, wherein the at least one interlocking element is an integrated portion of the rotor core.

4. The rotor of claim 1, comprising a plurality of permanent magnets arranged on the opposite side of the rotor core relative to the recesses.

5. The rotor of claim 4, wherein each one of the plurality of permanent magnets is arranged to a corresponding position relative to one of the recesses, respectively.

6. The rotor of claim 1, wherein the recesses extend into the rotor core a first distance being at least 0.30 times a height of intermediate portions of the rotor core between two adjacent ones of the recesses.

7. The rotor of claim 4, wherein each one of the plurality of permanent magnets is wider than the recesses at the corresponding position at their base in a perpendicular direction relative to the width direction.

8. The rotor of claim 1, wherein at least portion of an edge of the recesses is curved or has an arc shape starting from an edge of the base and continuing towards bottom of the recess.

9. The rotor of claim 1, wherein the rotor core is discontinuous in the recess on the opposite side of the plurality of support members relative to the rotor core.

10. The rotor of claim 1, wherein the plurality of support members are arranged completely into the recesses in a thickness direction of the rotor core.

11. The rotor of claim 1, adapted to be arranged outside a stator of the electric motor.

12. An electric motor comprising:
a stator comprising a stator core and one or more motor windings arranged for providing an electromagnetic coupling between a rotor and the stator, wherein the rotor is in accordance with claim 1.

13. The electric motor of claim 12, wherein the rotor comprises, on the opposite side of the rotor core relative to the recesses, a plurality of permanent magnets facing a plurality of stator teeth.

14. The electric motor of claim 12, wherein a height of the rotor core is 0.7-1.3, preferably about 1.0, of the height of intermediate portions of the stator core between two adjacent ones of the recesses of the stator core.

15. The electric motor of claim 12, comprising a support element arranged in contact with the stator core on the opposite side of the stator core relative to the plurality of stator teeth, wherein:
the support element comprises protrusions on a surface thereof at corresponding positions with respect to the recesses of the stator core, and
the protrusions are adapted so that they fit into the recesses and provide interlocking between the support element and the stator core, preferably by the opposite sides surfaces of the recesses of the stator core being very close to, such as being less than 0.5 millimeter away from, or, even more preferably, in contact with corresponding opposite side surfaces of the protrusions.

16. The electric motor of claim 15, wherein the support element is arranged so that the protrusions are completely in the recesses, and a surface portion of the support element facing the stator core and between the protrusions is in contact against the corresponding surface of the stator core.

17. An electric motorcycle comprising an electric motor of claim 12, wherein the electric motor is arranged to rotate at least one wheel of the electric motorcycle.
